(19) United States
(12) Patent Application Publication
(10) Pub. No.: US 2009/0019313 A1
(43) Pub. Date: Jan. 15, 2009

(54) SYSTEM AND METHOD FOR PERFORMING CLIENT-SIDE INPUT VALIDATION

(76) Inventors: Ramesh Pokala, Kondapur (IN); Prasad Pillala, Chanda Nagar (IN)

Correspondence Address: PILLSBURY WINTHROP SHAW PITTMAN, LLP, P.O. BOX 10500, MCLEAN, VA, 22102, US

(21) Appl. No.: 11/775,617

(22) Filed: Jul. 10, 2007

(51) Int. Cl. G06F 11/00

(52) U.S. Cl. 714/37

(57) ABSTRACT

A system and method for performing client-side input validation may include a JavaServer Faces (JSF) environment having parameters indicating whether to enable or disable client-side validation for a given application, and one or more validation functions for validating required fields, minimum and maximum values, regular expressions, input lengths, or other input parameters.

### COPYRIGHT NOTICE

A portion of this disclosure contains material in which copyright is claimed by the applicant. The applicant has no objection to the copying of this material in the course of making copies of the application file or any patents that may issue on the application, but all other rights whatsoever in the copyrighted material are reserved.

### FIELD OF THE INVENTION

The invention relates to performing client-side input validation for user interface components, and in particular, to validating data entered by a user in a JavaServer Faces (JSF) application.

### BACKGROUND OF THE INVENTION

In a variety of client-server systems and applications, it may be useful validate user inputs. For example, a web-based application may include a variety of input fields or other input parameters, which may be validated for a data type (e.g., a valid input may require a number rather than text), a data format (e.g., a valid date may be required to be in a particular form, such as MM/DD/YYYY, DD/MM/YYYY, etc.), a data range (e.g., a valid input number may be restricted to a range, such as between 1 and 100), or other factors, as will be apparent.

Existing systems typically perform server-side input validation for applications that communicate between a client and a server. Server-side validation includes transmitting data that has been entered into an application by a user to an application server (e.g., via HyperText Transfer Protocol), where validation criteria may be applied against the input. When the input violates the validation criteria (e.g., because of an incorrect data format), the server would communicate an error to the client, and the data would have to be reentered, retransmitted, and revalidated until the data satisfies the validation criteria. As such, server-side validation can potentially introduce significant communication bottlenecks by transferring excessive amounts of data over a network, in addition to potentially degrading server response time, utilization, or other aspects of the server's performance.

One way in which existing systems attempt to add client-side validation to web applications includes developing custom validation scripts to perform the client-side validation. In this approach, a developer has to manually develop the scripts and plug the scripts in at appropriate HyperText Markup Language (HTML) elements. Moreover, as any given HTML component may be generated by a tag, the developer must also know an HTML element structure of the component in order to properly plug in the validation script. As such, custom scripts for perform client-side input validation can often be a tedious and error-prone process.

Existing systems suffer from these and other problems.

### SUMMARY OF THE INVENTION

According to various aspects of the invention, a system and method for performing client-side input validation may address these and other drawbacks of existing systems, for example, by providing a generic framework for performing client-side input validation. In various implementations, the validation framework may leverage JavaServer Faces (JSF) technology to perform client-side validation of a JSF input component by incorporating validation scripts (e.g., JavaScript) for various input types. For example, a developer may create a web application including one or more JSF input components, and the developer may enable client-side input validation for the JSF components by implementing a validator associated with the generic framework, and by indicating which validator script to use for the client-side validation. As such, client-side validation can easily be enabled for any JSF input component, without requiring a developer to manually develop validation code (e.g., a custom JavaScript) or account for how and/or where to plug-in the code for each component.

According to various aspects of the invention, a generic JSF validation framework may include a base class for a various interfaces used in JSF environments. For example, the base classes may provide fully extensible interfaces for a validator and a validator renderer, which can be implemented (e.g., extended) to provide client-side validation for a specific input case associated with a JSF input component. The generic framework may include validators for various common input types (e.g., date ranges, numerical ranges, length ranges, regular expressions, required fields, etc.), and may be fully extensible to enable creation of additional validators that can perform specific types of client-side validation.

According to various aspects of the invention, performing client-side input validation in a JavaServer Faces (JSF) environment may include receiving a web page that includes at least one JSF input component, wherein the JSF input component may be associated with at least one validator tag defining a valid input for the input component. The web page, which includes at least one input field corresponding to the input component, may be presented to a user. The validator tag may be rendered (e.g., processed) to generate source code that performs validation for the input field. For example, the generated source code may include a statement that invokes a validation function (e.g., a JavaScript function), which determines whether an input received in the input field satisfies the valid input definition.

Other objects and advantages of the invention will be apparent to those skilled in the art based on the following drawings and detailed description.

### BRIEF DESCRIPTION OF THE DRAWINGS

FIG. 1 illustrates a block diagram of an exemplary client-server system according to various aspects of the invention.

FIG. 2 illustrates a block diagram of exemplary client-side rendering of HyperText Markup Language (HTML) objects according to various aspects of the invention.

FIG. 3 illustrates an exemplary modular validation framework according to various aspects of the invention.

FIG. 4 illustrates a flow diagram of an exemplary validation operation according to various aspects of the invention.

FIG. 5 illustrates a hierarchical view of exemplary validators according to various aspects of the invention.

FIG. 6 illustrates a hierarchical view of exemplary renderers according to various aspects of the invention.

### DETAILED DESCRIPTION

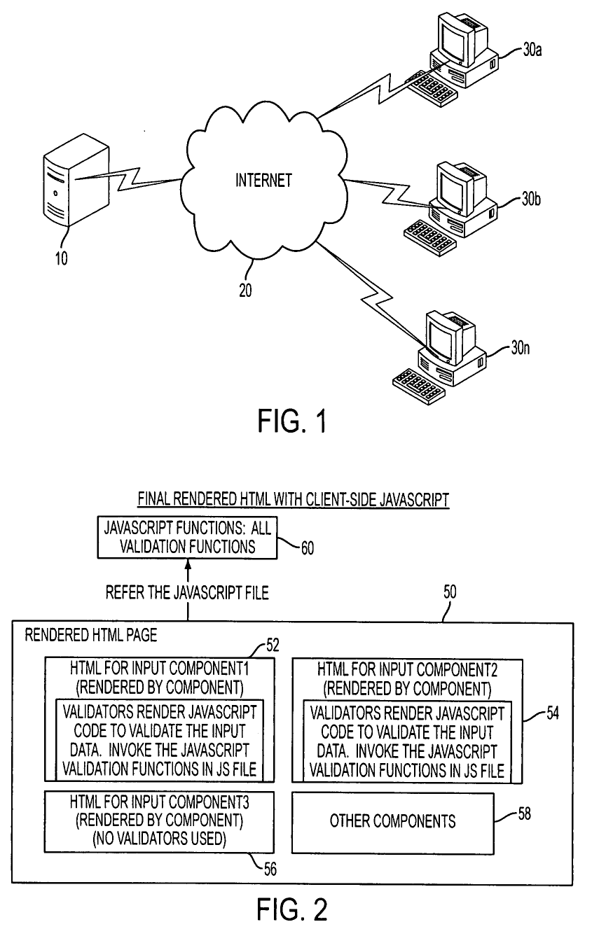

Referring to FIG. 1, a block diagram of an exemplary client-server system is illustrated according to various aspects of the invention. As illustrated in FIG. 1, the client-server system may include a server 10 in communication with a plurality of client systems 30a, 30b, . . . , 30n. The server 10 and the plurality of client systems 30a-n may be coupled via a network 20, which may span one or more local or wide area networks, wireless networks, or other network connections, as will be apparent. Upon receiving a request from one or more of clients 30a-n, server 10 may provide an appropriate response to the request, which may include, for example, HyperText Markup Language (HTML) documents, code for rendering HTML documents, a web application, or various other forms of data, as will be apparent. The requesting client would then process the response by performing various local tasks, as necessary.

For example, in a typical client-server implementation, a client (e.g., client 30a) may request a web-based application from server 10, in which the requested application may include, for example, a Java application that can be rendered in a browser at the client 30a. The Java application may include various active code modules that can be interpreted or executed in a runtime environment at the client 30a. For example, the application may include script-based Java code (e.g., JavaScript), display components for rendering images, text, or other information in a user interface, input components for receiving input from a user (e.g., text boxes, password text boxes, radio buttons, check boxes, etc.).

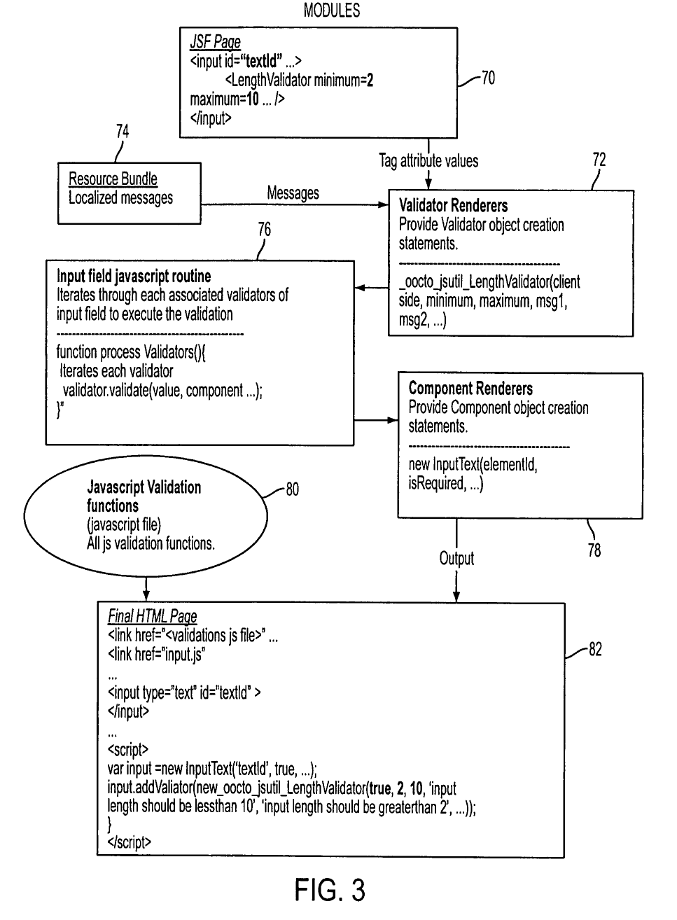

In various instances, input received from the user may be communicated to the server 10 for further processing (e.g., the server 10 may provide protected information to be used with the application upon authenticating a username and/or password). As such, in accordance with various aspects of the invention, communication overhead and server processing time may be made more efficient by validating the input (e.g., according to type, range, or other restrictions) prior to communicating the data to server 10. For instance, as illustrated in FIG. 2, a server may provide an HTML page 50 to a client, which may be rendered within a web browser installed at the client. The HTML page 50 may include one or more components, including various input components 52, 54, 56, or other components 58. Although the server provides HTML code in the illustrated example, it will be apparent that other suitable languages or data formats may be substituted as necessary or desirable. In the illustrated example, input components 52 and 54 include validators that render JavaScript code for validating input associated with the components 52 and 54. The validators refer to a JavaScript file 60, which includes one or more JavaScript functions for validating various forms of input. As such, when rendering components 52 and/or 54 to be displayed in a browser, an input component (e.g., a text box) associated with the rendered components 52 and/or 54 may be displayed within the browser, while the validators associated with the rendered components 52 and/or 54 invoke an appropriate validation function from the JavaScript file 60 to validate an input received at the input component.

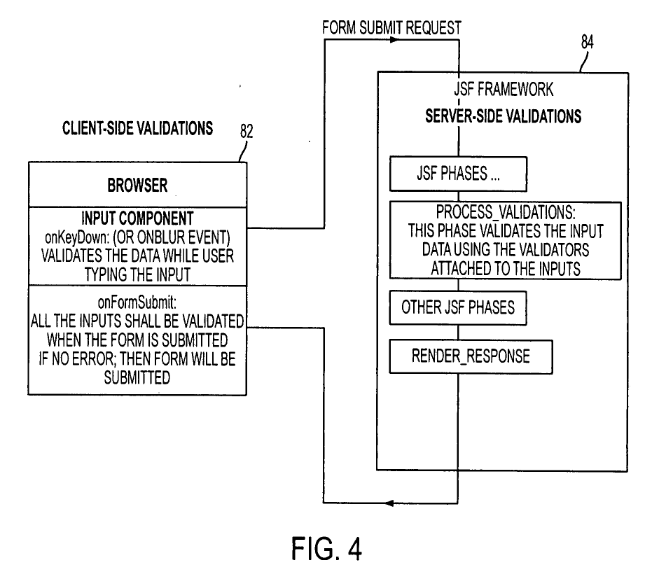

Referring to FIG. 3, an exemplary framework for performing client-side input validation is illustrated according to various aspects of the invention. A developer may use the framework illustrated in FIG. 3, for example, to validate an input for a JavaServer Faces (JSF) input component 70. For example, as illustrated in FIG. 3, the JSF component 70 includes a tag that defines an input (i.e., “textId”), which has been associated with a range validator (i.e., “LengthValidator”) to constrain a length of the input between a minimum of two and a maximum of ten.

When processing the JSF component 70 for display in a browser, attribute values for the input tag (e.g., the range validator) may be identified and provided to an appropriate validator renderer 72, together with one or more localized messages from a resource bundle 74. The validator renderer 72 uses the tag attributes and the localized messages to generate one or more statements for creating a validator object (e.g., text strings that invoke validation functions corresponding to each validation specified in the JSF component 70). For example, as shown in FIG. 3, the validator renderer 72 receives attribute values associated with a JSF component input tag (e.g., “LengthValidator minimum=2 maximum=10”), along with one or more English language messages (e.g., “msg1,” “msg2”), and subsequently generates a statement that can create a corresponding validator object (e.g., “_oocto_jsutil_LengthValidator(clientSideTrueOrFalse, minimum, maximum, msg1, msg2, . . . ”). In other words, the validator renderer 72 represents JSF validation code in a statement format that includes a Boolean parameter indicating whether to enable client-side validation, the minimum string length, the maximum string length, and the messages from resource bundle 74.

Subsequently, a JavaScript routine 76 iterates through each validator associated with an input field by the validator renderer 72 to execute the validation. A component renderer 78 then generates one or more statements for creating an object corresponding to the input component defined in the JSF page 70. The component renderers 78 subsequently provide the object creation statements to a final HTML page 82 that can be displayed in a client browser. Final HTML page 82 may reference a JavaScript file 80 that includes JavaScript functions for performing client-side validation of various input components.

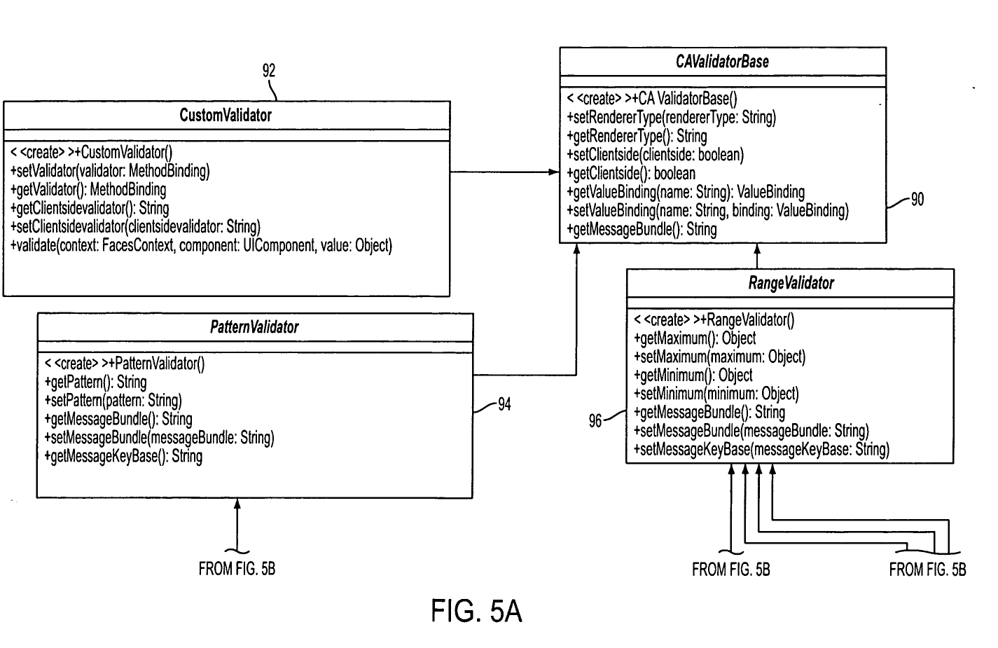

For example, in exemplary implementations, input validation may be performed as a user provides input values to one or more input components of a client-server application. As illustrated in FIG. 4, the input validation framework may enable a developer to specify client-side input validation (e.g., within a client browser 82), server-side input validation (e.g., by maintaining validation framework libraries at a server 84), or various combinations thereof.

When performing client-side validation, an input provided by a user may be validated while the user types the input (e.g., by monitoring for a key press using onKeyDown, onKeyUp, or other key press functions, or for a change of focus using onBlur or other functions that monitor for changes in focus, or other similar functions). Further, input validation can be set to occur only upon receiving a page submission or other action indicating completion of the input (e.g., validating all inputs when submitting a form using onFormSubmit, or a similar function). In either case, when no errors or warning conditions occur as a result of the validation, the input data may be provided to a server for further processing. If, however, the validation results in one or more inputs being found invalid, an error message may be returned to a user to identify the invalid input and/or provide explanatory text, icons, audible alarms, or other indicators. Further, the validation functions may be defined to differentiate between an error and a warning condition based on a severity or importance of a given validation.

Within the same framework, when server-side validation has been enabled, the input data may be transferred to the server 84 upon receiving a form submit request, and the server 84 may validate the input data using one or more validators attached to the inputs in accordance with the validation framework. The server's response, if any, would then be passed back to the client browser 82 to be rendered to the user's display.

According to various aspects of the invention, functionality for performing client-side input validation may be provided for any suitable Java-based web application developed in accordance with the JSF framework. The framework includes a script file, which includes JavaScript functions that perform validation upon being called by script code rendered within a JSF component. Developers can use the modular, generic nature of the framework to select whether to enable client-side validation for content to be served to clients. Further, the framework may be fully extensible to allow developers to customize validation parameters, including server-side input and output.

The validation framework may include, among other things, an input validation function that iterates over each validator associated with an input field and that invokes one or more validator functions associated a current validator iteration. Each validator may be associated with one or more validation functions, which receive as parameters an input, validator values, and/or error/warning messages. For example, the framework may include validation functions for various common input types and/or data formats, including, among other things, a date range validator (e.g., to validate that an input falls within a specified date range), a numerical validator (e.g., to validate that a numerical input falls within a specified numerical range), a form validator (e.g., to perform form-level validation by validating that all required fields include an input value), a length validator (e.g., to validate that an input string includes an acceptable number of characters), a regular expression validator (e.g., to validate that input data matches a specified regular expression).

Each of the validator functions may be defined to receive one or more parameters, including, for example, acceptable ranges, action to take upon identified an error or warning condition (e.g., displaying a text string), or other validation parameters. As an example, a numerical range validator may be defined as follows:

_oocto_jsutil_DoubleRangeValidator (2.5, 5.5, ‘Input out of range.
The input must be between 2.5 and 5.5.’)

In the illustrated example, the numerical range validator includes an acceptable range having a lower limit of 2.5 and an upper limit of 5.5. When the validator has been attached to a numerical input field and a user enters a value that does not fall within the acceptable range, the validator may display an error message corresponding to “Input out of range. The input must be between 2.5 and 5.5.”

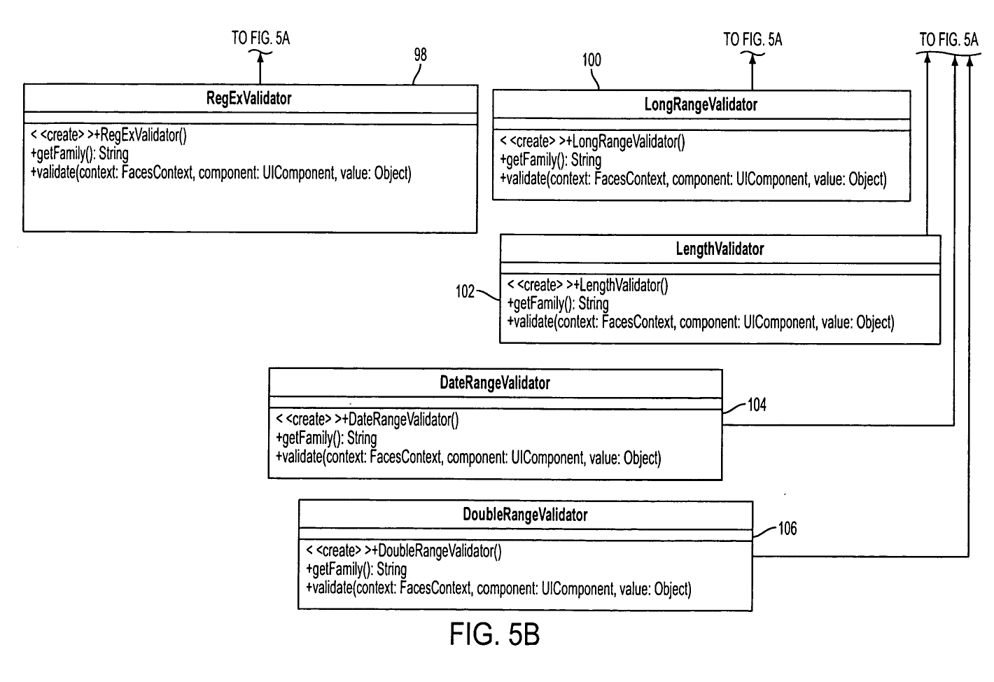

Referring to FIG. 5, a hierarchical view of the validators illustrates a generic base class 90 for a validator interface. As illustrated, the base class 90 includes extendable methods that enable a developer to establish various parameters for a validator, including getter and setter functions for identifying a renderer class to return for a validator tag (e.g., setRendererType and/or getRendererType), whether to enable/disable client-side validation for a validator (e.g., setClientSide and/or getClientSide), how to formulate queries for properties associated with a validator based on a tag definition (e.g., setValueBinding and/or getValueBinding), or which message bundle to search for custom error or alert messages (e.g., setMessageBundle and/or getMessageBundle).

To implement a client-side validator for an input component, a developer can extend the base validator class 90 by implementing a pattern validator 94, a range validator 96, and/or a custom validator 92, depending on a desired input type. As with the base validator class 90, each second tier validator may include a number of additional functions or parameters as illustrated in FIG. 5. For example, the pattern validator 94 includes a subclass RegExValidator 98 for validating regular expressions, while RangeValidator 96 includes subclasses for validating long or double inputs (e.g., LongRangeValidator 100 and DoubleRangeValidator 106, respectively), length of a text string (e.g., LengthValidator 102), or date ranges (e.g., DateRangeValidator 104), among other things. It will be apparent that the validators illustrated in FIG. 5 provide but one exemplary implementation, and that other validators may be implemented to ensure that any type of input satisfies to a required format, type, range, or other criteria. For example, the validation framework includes an extensible custom validator 92 that can be adapted to validate inputs in a manner similar to that illustrated for other validators that depend from base validator 90.

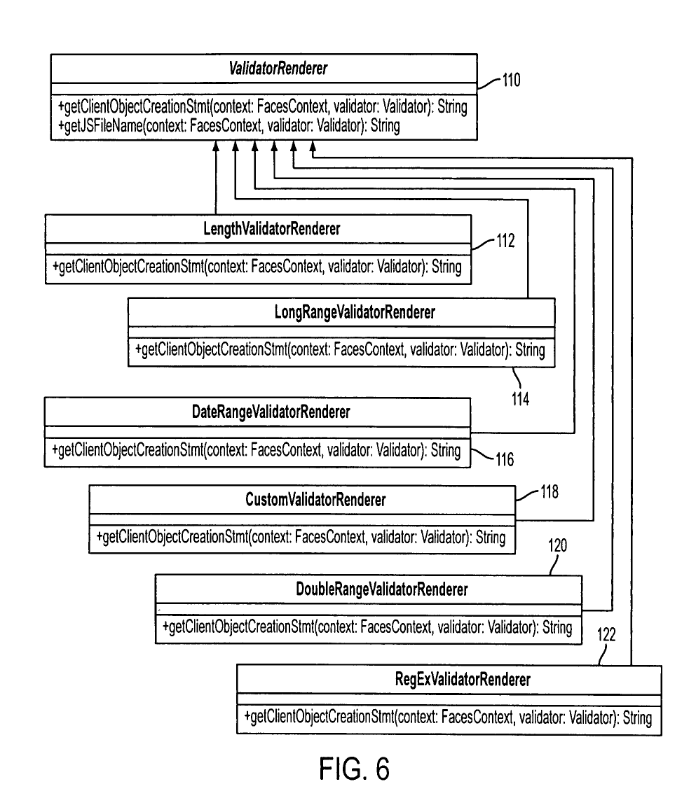

As described above in relation to FIG. 3, the validators may be rendered by a validator rendering module 72, in conjunction with any additional modules called or referenced by rendering module 72. For instance, referring to FIG. 6, a hierarchical representation of validator renderers may include a base renderer class (e.g., ValidatorRenderer 110), which returns a JavaScript object creation statement for a validator. As such, each validator may be associated with a corresponding validator renderer 112-122 that includes JavaScript instructions for returning an appropriate object creation statement for the associated validator. For instance, the following code sample provides a specific JavaScript implementation of a validator that verifies whether an input string falls includes an acceptable number of characters.

```
Client JS object implementation for Length Validator
    Function _oocto_jsutil_LengthValidator(clientside,
    minimum, maximum, msg1, msg2, msg3, msg4)
    {
        this.clientside = clientside;
        this.min = minimum;
        this.max = maximum;
        this.getMinimum = function( )
        {
            Return this.minimum;
        }
        this.getMaximum = function( )
        {
            Return this.maximum;
        }
        this.validate = function (jsFacesContext, component, value)
        {
            if (!this.clientside) return;
            if (value == null || value == ””) return;
            var length = value.length;
            var maximum = this.getMaximum( );
            var minimum = this.getMinimum( );
            if (maximum != null))
            {
                var maxValue = parseInt (maximum);
                if (length > maxValue)
                {
                    if (minimum != null){
                        throw new ValidatorException(msg1,
                        ValidatorException.SEVERITY_ERROR);
                    } else {
                        Throw new ValidatorException(msg2,
                        ValidatorException.SEVERITY_ERROR);
                    }
                }
            }
            if (minimum!= null))
            {
                var minValue = parseInt (minimum);
                if (length < minValue)
                {
                    if (maximum != null){
                        throw new ValidatorException(msg3,
                        ValidatorException.SEVERITY_ERROR);
                    } else {
                        Throw new ValidatorException(msg4,
                        ValidatorException.SEVERITY_ERROR);
                    }
                }
            }
    }
```

The JavaScript implementation illustrated above includes instructions for determining whether to enable/disable client-side validation, for setting a minimum and maximum length, and for comparing an actual input to the minimum and maximum length constraints that have been set. When validation fails, a message (e.g., msg1, . . . , msg4) can be rendered to a user depending on various characteristics of the failure, and appropriate exception can be called.

The following code sample illustrates how a developer can implement code to provide custom validation processes and/or error messages for an input component. In the illustrated example, custom validation for an input field that receives Long numerical values may be implemented by defining a validator function and a validator renderer class providing a JavaScript function call string for the defined validator.

```
function validateLongRange_Dev_Impl (value, min, max, errMessage)
{
    // sample validation code
    value = getLongValue (value); //calling the conversion function
    to get the long
    if (value < min || value > max) {
        throw new ValidatorException (errMessage,
        ValidatorException.SEVERITY_ERROR);
    }
    else {
        // valid data
        return true;
    }
}
public class CustomLongRangeValidatorRenderer extends
LongRangeValidatorRenderer
{
    public String getJSFunctionCall (Validator validator) {
        CustomLongRangeValidator v =
        (CustomLongRangeValidator)validator;
        return
        “new.validateLongRange_Dev_Impl(“+v.getMinimum( )+”,
        “+v.getMaximum( )+”,
        “+v.getErrorMessage( )+”)”;
```

Further, the developer can provide additional behavior in each or both of the classes. For example, the developer can override the validate method in the LongRangeValidator to validate the input data at server side, or override the getErrorMessage and getConversionErrorMessage methods to provide custom messages for the JavaScript methods.

In another example, a developer may elect to execute all validations upon receiving a form submit action, irrespective of whether or not input data has been entered and/or validated at a field-level (e.g., various cases may use default values for input fields, which will not be validated unless a user modifies the default values). The input data may be validated upon submission of the form, such that no validation occurs on field input actions, blur conditions, or the like. Next, the developer provides a custom JavaScript function for form-validation that will validate all the input fields in the form. The custom form-validation function can be generic enough to use in all the pages/forms or can be specific to a form, as necessary.

Implementations of the invention may be made in hardware, firmware, software, or any combination thereof. The invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described in the above disclosure in terms of specific exemplary aspects and implementations of the invention, and performing certain actions. However, those skilled in the art will recognize that such descriptions are merely for convenience and that such actions in fact result from computing devices, processors, controllers, or other devices executing the firmware, software, routines, or instructions.

Aspects and implementations may be described as including a particular feature, structure, or characteristic, but every aspect or implementation may not necessarily include the particular feature, structure, or characteristic. Further, when a particular feature, structure, or characteristic is described in connection with an aspect or implementation, it is understood that it is within the knowledge of one skilled in the art to effect such feature, structure, or characteristic in connection with other aspects or implementations whether or not explicitly described. Thus, various changes and modifications may be made, without departing from the scope and spirit of the invention. The specification and drawings are to be regarded as exemplary only, and the scope of the invention is to be determined solely by the appended claims.

What is claimed is:

1. A method for performing client-side input validation in a client-server environment, comprising:
receiving a web page that includes at least one input component, the input component associated with at least one validator tag defining a valid input for the input component;
presenting the web page to a user, the displayed page including at least one input field corresponding to the input component; and
invoking a renderer that generates source code from the validator tag, the generated source code, the generated source code operable to execute a validation script that determines whether an input received in the input field satisfies the valid input definition.

2. The method of claim 1, wherein the generated source code and the validation function include JavaScript code.

3. The method of claim 2, further comprising receiving a plurality of JavaScript validation functions, each of which perform validation for one or more input types.

4. The method of claim 1, further comprising identifying one or more attributes associated with the validator tag, wherein the source code that invokes the validation function is rendered based on the identified attributes.

5. The method of claim 4, the attributes including an identification of the validation function and one or more parameters defining the valid input.

6. The method of claim 5, the parameters including one or more of a regular expression, a numerical range, a date range, a minimum string length, and a maximum string length.

7. The method of claim 1, the generated source code further operable to execute the validation script by providing, to the validation script, one or more parameters associated with the valid input and one or more messages associated with an invalid input.

8. The method of claim 7, further comprising displaying at least one of the messages when the received input does not satisfy the valid input definition.

9. The method of claim 1, wherein the input component includes a JavaServer Faces (JSF) input component.

10. A system for performing client-side input validation in a client-server environment, comprising:
a plurality of validators, each of which extend a base validator to implement respective validator tags;
a plurality of validator renderers, each of which extend a base validator renderer to implement a renderer for a respective one of the validator tags; and
a client system that receives a web page including at least one input component, the input component associated with at least one of the validator tags, the client system operable to invoke one or more of the validator renderers that implement the renderer for the at least one validator tag, wherein the invoked renderer generates source code that executes one of a plurality of validation scripts that validate an input relating to the at least one validator tag.

11. The system of claim 10, the at least one validator tag including one or more attributes defining a valid input for the input component, the validation script operable to determine whether an input received for the input component satisfies the valid input definition.

12. The system of claim 11, the client system further operable to invoke one or more component renderers that renders an input field corresponding to the JSF input component, wherein a user provides the received input to the rendered input field.

13. The system of claim 12, the at least one input field including one or more of a text box, a radio button, a check box, a multiple select box, a single select box, a combo box, a list box, and a date picker.

14. The system of claim 11, wherein the generated source code includes a JavaScript function call having one or more parameters based on the validator tag attributes.

15. The system of claim 10, further comprising at least one input script operable to iteratively process the validator tags associated with the JSF input component.

16. The system of claim 15, wherein the generated source code, the validation scripts, and the input script include JavaScript code.

17. The system of claim 10, further comprising a resource module that includes one or more messages to be passed as parameters to the validation scripts.

18. The system of claim 10, the validators performing validation for one or more of a regular expression, a numerical range, a date range, a minimum string length, and a maximum string length.
